(19) United States
(12) Patent Application Publication
(10) Pub. No.: US 2007/0152527 A1
(43) Pub. Date: Jul. 5, 2007

(54) Reluctance motor

(75) Inventors: Motozumi Yura, Niwa-gun (JP); Takanori Yokochi, Niwa-gun (JP)

Correspondence Address: MCCARTER & ENGLISH LLP;CITYPLACE I, 185 ASYLUM STREET, HARTFORD, CT, 06103, US

(73) Assignee: OKUMA Corporation

(21) Appl. No.: 11/316,853

(22) Filed: Dec. 23, 2005

(51) Int. Cl. H02K 21/12

(52) U.S. Cl. 310/156.53

(57) ABSTRACT

To form magnetic poles P on a rotor, a plurality of slits extending along a radial direction in a region close to the magnetic poles P and extending along a circumferential or chord direction in mid areas between the magnetic poles P are formed. The width b of circumferential slit segments extending along the circumferential or chord direction is narrower than the width a of radius slit segments extending along the radial direction. Permanent magnets are disposed in the narrowed segments of the slits to suppress leakage of magnetic flux. Thus, in a motor in which magnetic paths separated by the slits are formed on the rotor to provide regions having different magnetic reluctances in a circumferential direction of the rotor, a structure in which a through hole penetrated by an output shaft of the motor can have a large diameter is provided.

The entire disclosure of Japanese Patent Application No. 2004-192543, including the specification, claims, drawings, and abstract, is incorporated herein by reference in its entirety.

### BACKGROUND OF THE INVENTION

1. Field of the Invention

The present invention relates to an electric motor (hereinafter simply referred to as “a motor”) using magnetic torque in combination with reluctance torque, and in particular to a structure in relation to a magnetic path in a rotor of the motor.

2. Description of the Related Art

As a first instance of background art of the present invention, there has been known a flux-barrier type reluctance motor such as that disclosed in Japanese Patent Laid-Open Publication No. Hei 11-206082. FIG. 5 shows an example of a cross sectional configuration of the motor. In this motor, a plurality of slits 2 are formed in a rotor 1 composed of laminated flat rolled magnetic steel sheets and strips, to thereby form a plurality of split magnetic paths 3. The split magnetic paths 3 constitute a route of magnetic flux in such a manner that magnetic reluctance to a magnetic flux flowing, for example, from a magnetic pole P1 to a magnetic pole P2 in FIG. 5 becomes low. The slits 2 forms a barrier which creates a high magnetic reluctance to a magnetic flux flowing, for example, into midpoints N1 and N2 between magnetic poles. A reason for providing the plurality of the split magnetic paths 3 and the slits 2 as described above is to split a magnetic pole section by the split magnetic paths in order to divide a torque ripple for suppression of overall torque ripple in the rotor.

In the motor shown in FIG. 5, a stator 4 has a plurality of slots 5 formed thereon, and an electrical wire is inserted into the slots 5 to configure a stator winding similar to those used in general AC motors.

In FIG. 5, the rotor 1 includes, in the center thereof, a hollow shaft 6 inserted therein. When the motor is used for a spindle of a lathe, for example, a hollow part in the shaft 6 is penetrated by an object having the shape of a round bar to be processed (a workpiece). In contrast, when the motor is used for a spindle of a machining center, the hollow part in the shaft 6 is penetrated by a linkage (drawbar) necessary for retaining a tool. Therefore, the hollow part desirably has as large a diameter as possible.

As a second instance of background art of the present invention, there has been known a permanent magnet embedded motor such as that disclosed in Japanese Patent Laid-Open Publication No. 2002-78259. In this motor, as shown in FIG. 6, permanent magnets are embedded to fill the entire interior of each slot formed in a rotor. The purpose of embedding the permanent magnets in this manner is to produce a magnetic flux in a direction opposite a direction of a leakage flux passing through the slits, by means of the permanent magnets, in order to reduce the leakage flux for generation of increased reluctance torque. In addition, a Lorentz force is created between the magnetic flux generated by the permanent magnets and a current passing through the stator winding, thereby further increasing the output torque.

As a third instance of background art of the present invention, Japanese Patent Laid-Open Publication No. 2002-272031 discloses another permanent magnet embedded motor. A rotor structure of this motor is shown FIG. 7. Slits 2 shown in FIG. 7 include, only in central portions thereof, permanent magnets 7 embedded therein. Although, similar to the second instance, the purpose of using the permanent magnets is to increase an output torque, flat-shaped permanent magnets are used in the third example in order to simplify a production process of the permanent magnets, which can facilitate reduction of production cost.

A fourth instance of background art of the present invention is another permanent magnet embedded motor as taught by Morimoto, Ueno, and Takeda in “Wide Speed Control of Interior Permanent Magnet Synchronous Motor”, Technical Report Vol. 114-D, No. 6, p 668 published by the Institute of Electrical Engineers of Japan in 1994. FIG. 8 shows a rotor structure of the motor in this instance. This instance is similar to the third instance shown in FIG. 7, in that permanent magnets are embedded in central portions of slits 2, but differs from the third instance in that the rotor in the motor of the fourth instance includes only one slit between each set of linked magnetic poles and has no split magnetic paths. Therefore, the motor of the fourth instance has a great torque ripple, and is not applicable to use for a spindle of a machine tool or the like in which a high degree of rotation accuracy is required.

Problems to be solved in the above-described conventional motors will be described below. In the motor of the first instance, the leakage flux passing through the slits 2 shown in FIG. 5 must be minimized in order to produce a sufficient reluctance torque. In this connection, the width of the slits 2 must be made as wide as possible. However, such increased width of the slits 2; in particular, an increase in width of those located near the center of the rotor, leads to a problematic situation that the diameter of the shaft 6 cannot be widened.

In the motor of the second instance, because the permanent magnets embedded in the entire interior of each of the slits 2 as shown in FIG. 6 can help suppress leakage flux, the width of the slits 2 can be reduced, which allows an increase in diameter of the shaft 6. To secure proper performance of the motor, however, a rare-earth magnet must be used, which results in an increase in cost, because the motor employs a large volume of permanent magnets.

In the motor of the third instance, because the permanent magnets are embedded only in the central regions of the slits 2 of FIG. 7, great leakage flux exists in edge regions of the slits 2 where the permanent magnets are not embedded. Consequently, the overall width of the slits 2 must be increased, which problematically hampers an increase in diameter of the shaft 6.

Because, as shown in FIG. 8, the plurality of slits and the split magnetic paths are not provided in the motor of the fourth instance, the motor of the fourth instance suffers from a problem of a great torque ripple.

Accordingly, it is desired to provide an electric motor in which a large through hole can be formed in a center of a rotor for inserting a shaft of the motor, and permanent magnets to be used are reduced in volume to lower manufacturing cost of the motor, while suppressing torque ripples.

### SUMMARY OF THE INVENTION

An electric motor according to the present invention comprises a stator which produces a rotating magnetic field by applying a current to a winding; a rotor formed in a roughly cylindrical shape and rotated in synchronism with the rotating magnetic field, in which a plurality of split magnetic paths separated into strips by a plurality of slits and connecting adjacent magnetic poles are formed to arrange magnetic poles on a circumference of the rotor; and permanent magnets placed in the plurality of slits. The plurality of slits are composed of a combination of radial slit segments formed in close proximity to a surface of the magnetic poles substantially along a radial direction from a rotor surface toward a center of the rotor, and circumferential slit segments formed in an inner region of the rotor substantially along a circumferential direction or a chord direction between adjacent magnetic poles. In addition, each of the circumferential slit segments is smaller in width than the radial slit segments, and the permanent magnets are placed only in the circumferential slit segments in such a manner that at least one of the circumferential slit segments includes the permanent magnets at least in areas close to the edges of the circumferential slit segments.

By making the circumferential slit segments smaller in width than the radial slit segments, it becomes possible to increase a diameter of a through hole formed in the rotor for inserting a shaft of the motor in the through hole. Further, in the circumferential slit segments of the smaller slit width, occurrence of a leakage flux can be suppressed by the placement of the permanent magnets. Because leakage flux is likely to occur, in particular, at locations in close vicinity of the edges of the circumferential slit segments, the permanent magnets are preferably placed at locations near the edges in the circumferential slit segments.

Further, the permanent magnets may be separately placed at both edges of the circumferential slit segments so as to be spaced apart from each other, thereby facilitating reduction of the number of the permanent magnets to be used.

### BRIEF DESCRIPTION OF THE DRAWINGS

A preferred embodiment of the present invention will be described in detail by reference to the following figures, wherein:

FIG. 1 schematically shows a sectional view of an electric motor according to an embodiment of the present invention taken along a plane orthogonal to an axis of the electric motor;

FIG. 2 shows a detailed sectional view of a rotor in the electric motor of FIG. 1;

FIG. 3 schematically shows a sectional view of a rotor in an electric motor according to another embodiment of the present invention taken along a plane orthogonal to an axis of the rotor;

FIG. 4 is a graph showing a relationship between the volume of a permanent magnet and a torque in the electric motors having the rotors shown in FIGS. 2 and 3;

FIG. 5 is a sectional view showing a rotor and a stator in a conventional electric motor, which is a reluctance motor of multilayer slit type;

FIG. 6 is a sectional view of a rotor in a conventional electric motor;

FIG. 7 is a sectional view of another rotor in a conventional electric motor; and

FIG. 8 is a sectional view of still another rotor in a conventional electric motor.

### DESCRIPTION OF THE PREFERRED EMBODIMENTS

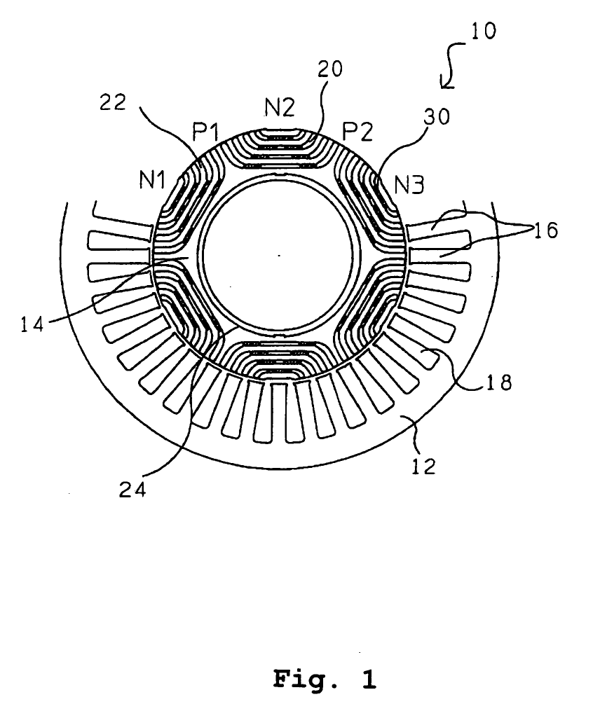

By reference to the drawings, a preferred embodiment of the present invention will be described below. FIG. 1 schematically shows a sectional structure of an electric motor according to the present embodiment. An electric motor 10 of this embodiment comprises a stator 12 which produces a rotating field and a rotor 14 rotated by an interaction with the rotating field. The stator 12 has teeth 16 arranged along an inner circumference thereof, and a coil conductor wire (winding) is inserted in slots 18 between the teeth 16 so as to wind the teeth 16. The rotating field is generated by applying a predetermined current to the winding. The rotor 14 is formed in a roughly cylindrical shape by laminating flat rolled magnetic steel sheets and strips having been die-cut into a predetermined shape. The flat rolled magnetic steel sheets and strips to be laminated have a sectional form as shown in FIG. 1. More specifically, a plurality of slits 20 extending side by side are die-cut to form regions remaining between the slits 20 as split magnetic paths 22. A plurality of the split magnetic paths 22 are arranged side by side to constitute a magnetic path connecting a magnetic pole Pn to its adjacent magnetic poles Pn−1 and Pn+1 on an outer surface of the rotor, thereby reducing a magnetic reluctance in a region of the magnetic pole P on the rotor. In addition, such multilayer slits 20 form a magnetic barrier to the passage of a magnetic flux flowing, for example, from midpoints N1 to N2 to thereby increase a magnetic reluctance in a region of a midpoint N between magnetic poles. In such configuration that the magnetic resistance varies depending on locations in the rotor as described above, when a current is applied to the stator winding, a reluctance force is generated, thereby producing a torque.

A shaft 24 is inserted in the center of the rotor 14. The shaft 24 has a hollow center, and the hollow center is penetrated by, for example, a round-rod-shaped object to be processed (a workpiece) when the shaft 24 is used for a spindle of a lathe or penetrated by a linkage (drawbar) necessary for retaining a tool when the shaft 24 is used for a spindle of a machining center.

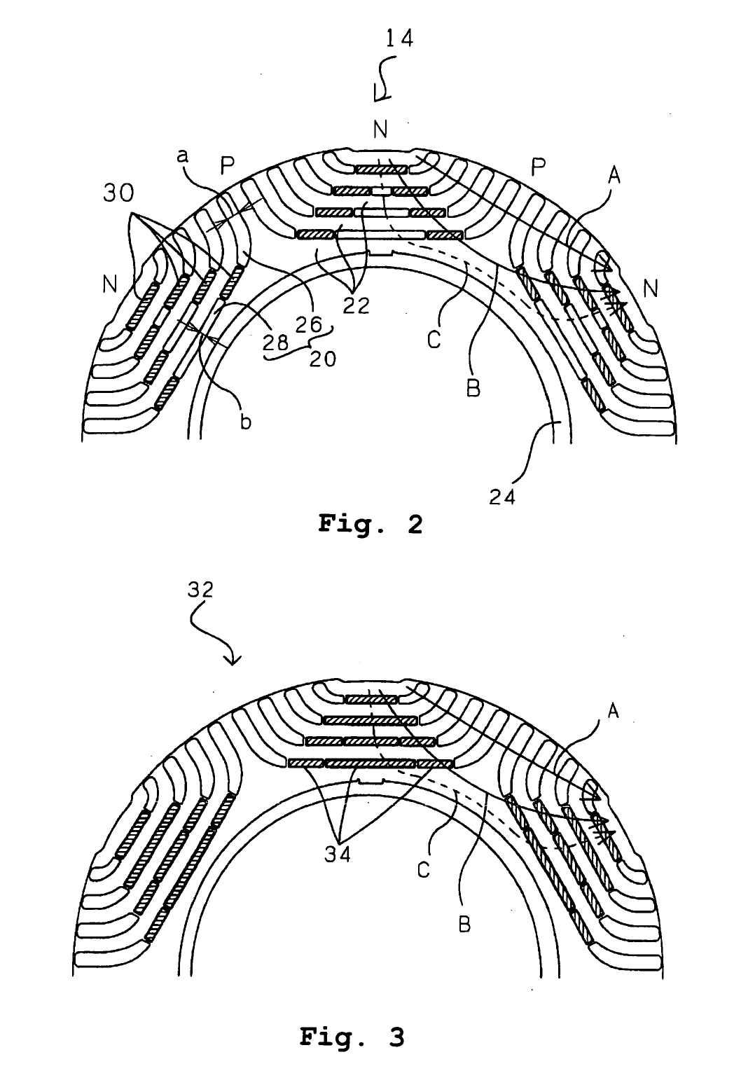

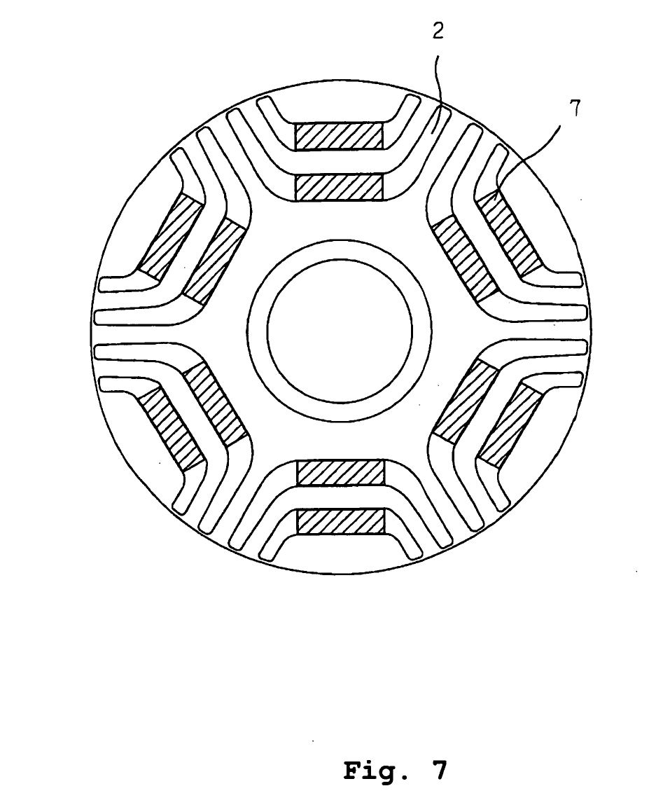

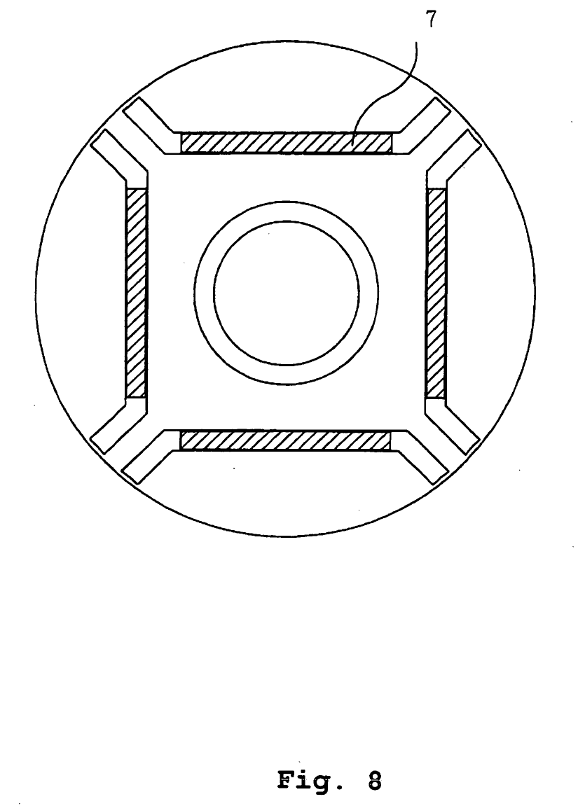

FIG. 2 shows detailed forms of the slits 20 and the split magnetic paths 22 on the rotor 14. Each of the slits 20 comprises radial slit segments 26 extending along a radial direction of the rotor in a region close to the magnetic pole P, and a circumferential slit segment 28 extending along a circumferential direction or along a direction of a chord connecting the magnetic poles in the rotor. It can also be said that the circumferential slit segment 28 extends in a direction which crosses the radial direction. Each of the slits 20 has a width b in the circumferential slit segment 28, which is smaller than a width a of the radial slit segment 26. By forming the circumferential slit segments 28 so as to connect the magnetic poles along a roughly straight line and imparting the smaller width to the circumferential slit segments 28, the through hole penetrated by the shaft 24 can be larger in diameter. In the conventional technology shown in FIG. 6, slots are formed in a curved shape significantly extending toward the inside. However, because such curved shapes are not formed in the present embodiment, the through hole can be made larger. Meanwhile, in the conventional technology shown in FIG. 7, because the slits are not configured to be narrowed in the circumferential slit segments, the slits are extended to a degree not narrowed in the circumferential slit segments toward the center of the rotor, thereby hampering formation of the larger through hole. The circumferential slit segments 28 which are formed in a roughly linear shape in the present embodiment may have an arc-shaped form; i.e. a shape curved slightly outward at the central portion.

As a result of narrowing the width of the slits 20 in the circumferential slit segments 28 as described above, the effect of the slits functioning as a magnetic barrier is reduced, thereby causing an increase in the amount of leakage of magnetic flux. Consequently, the difference in magnetic reluctance becomes smaller, resulting in a reduction in magnitude of the reluctance force. In the present embodiment, there is also provided a structure capable of suppressing the leakage of magnetic flux that occurs due to the slit width being narrowed, to realize a rotor constitution in which the hollow has the greater diameter and results in the reduction of the reluctance force. Specifically, the leakage suppressing structure is realized by placing permanent magnets at both edges of the circumferential slot segments 28. The principle underlying this structure is obtained from an analysis of each path of leakage flux, as will be described below. FIG. 2 shows paths A, B, and C through which magnetic flux leaks.

Because the slits located along the path A (the radial slit segments) are not narrowed in width, magnetic reluctance is significantly high in the path A. Therefore, the leakage flux is sufficiently suppressed.

In the path B, the narrowed slit widths cause the leakage flux to increase. With this in view, permanent magnets 30 are disposed in regions where the slit widths are narrowed; i.e., in the circumferential slit segments 26. The permanent magnets 30 (shown by hatched lines in FIG. 2) are placed so as to generate magnetic flux in a direction opposite the direction of the magnetic flux passing through the slits, thereby producing an effect of canceling the leakage flux. In this manner, the leakage flux can be reduced. Meanwhile, because the path C is longer than the path B, the magnetic reluctance is high in the path C. Further, because the magnetic flux tends to travel the shortest possible distance, the amount of magnetic flux which travels through the path C is less than that of magnetic flux which travels through the path B. Accordingly, even though the permanent magnets are not placed in central portions of the circumferential slit segments, the amount of leakage flux traveling through the path C is substantially small. As such, a superior motor in which the amount of leakage flux is small in all the paths A, B, and C can be realized.

FIG. 3 shows an example modification of the rotor. Because a rotor 32 in this example modification has a structure almost identical with that of the rotor 14, like elements in each of the rotors 14 and 32 are identified by the same reference numerals, and description thereof is not repeated. A distinctive feature of the rotor 32 lies in an arrangement of permanent magnets 34 placed so as to fill the entire length of the circumferential slit segments 28. In FIG. 3, areas indicated by hatched lines represent the permanent magnets 34. Although, in the rotor 32, the volume of used permanent magnets becomes slightly greater than that in the rotor 14, the permanent magnets 34 are disposed in the entire interior of the circumferential slit segments 28 so as to minimize the leakage flux traveling through the path C. As a result, the volume of permanent magnets used is increased as compared with the example shown in FIG. 2, while the amount of leakage flux can be further reduced, thereby yielding an increase in output torque per unit of volume of the motor. Therefore, the motor can be reduced in size.

The placement of permanent magnets may be changed in a variety of ways in consideration of performance, cost, and other conditions. Although the placement of permanent magnets in close vicinity of edges of the circumferential slit segments 28 can produce significant effects as described above, not all the slits necessarily include the permanent magnets placed only at the edges so as to be spaced apart from each other. In the rotor 14 depicted in FIG. 1, the outermost circumferential slits on the rotor 14 include the permanent magnets throughout their lengths, because the length of the slits is short. In general, the permanent magnets are preferably placed in the entire interior of each circumferential slit segment located in an outer area of the rotor, while being placed separately on both edges of each circumferential slit segment located in an inner area of the rotor. In addition, although the split magnetic paths are formed from four slits, the number of slits is not limited to four.

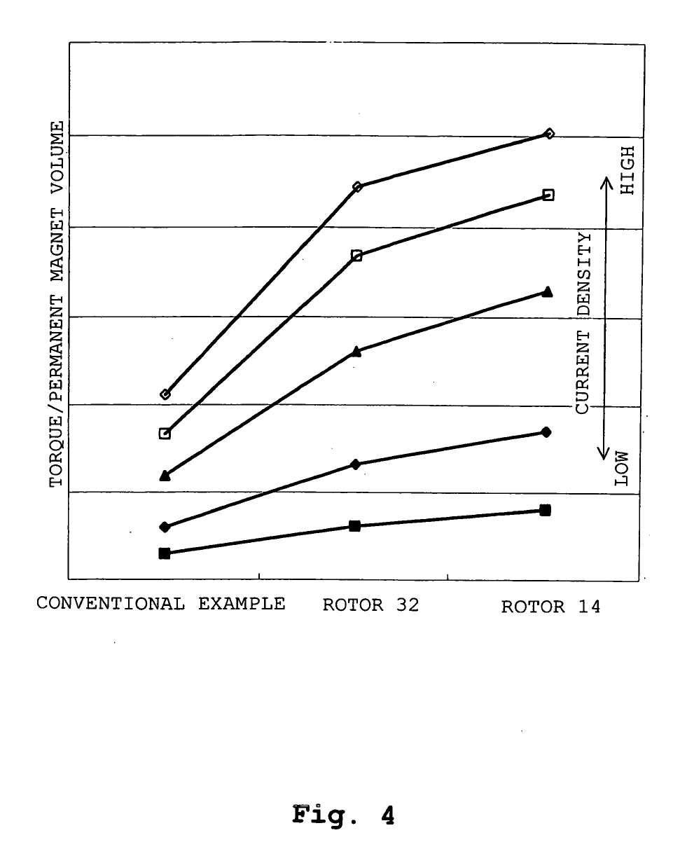

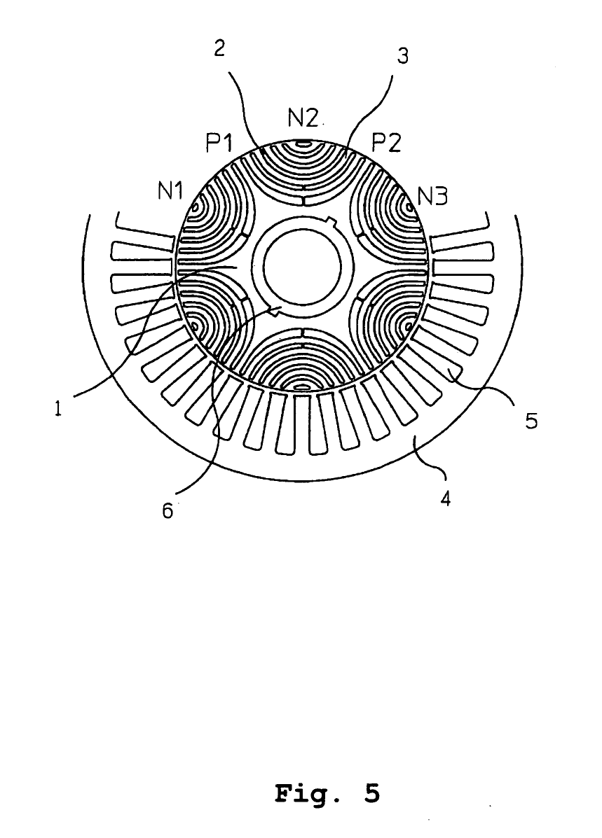

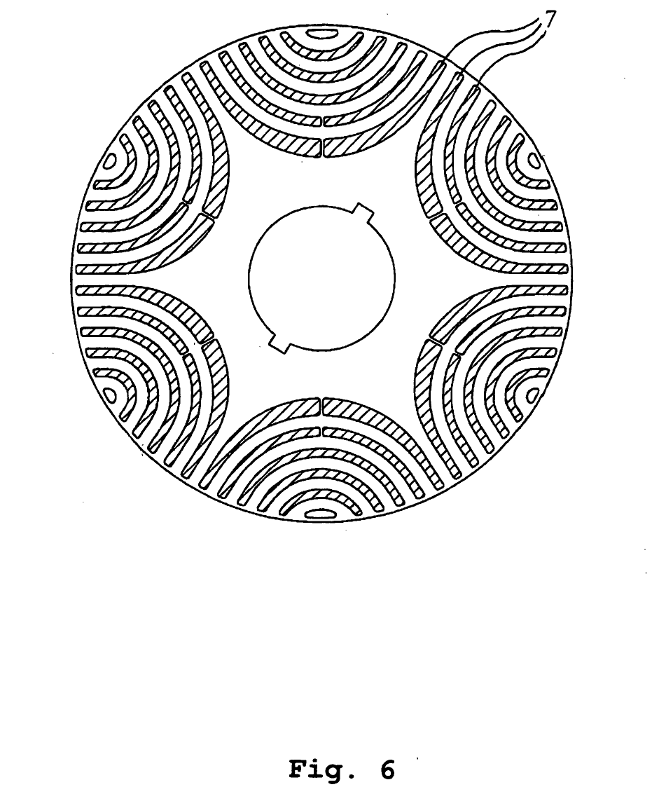

Next, the above-described embodiments are further described in terms of significant effects over conventional technologies. FIG. 4 shows a graph which gives a comparison of the magnitude of output torque relative to the volume of used permanent magnets obtained by changing values of current density in the motors according to the above-described embodiment and a conventional motor. In the comparison shown in the graph of FIG. 4, a motor having a rotor in which the permanent magnets are embedded in the entire interior of each of the slits as shown in FIG. 6 is cited as the conventional motor, while a motor using the rotor 14 and a motor using the rotor 32 is cited as a motor of this embodiment. As can be seen from FIG. 4, the motors according to the present embodiment can provide an output torque per unit of volume of permanent magnets about 2 to 2.5 times that provided by the conventional motor in which the permanent magnets are disposed in the entire interior of each of the slits. In other words, the total volume of the permanent magnets can be reduced in the motor of the present embodiment to approximately ½˜ 1/2.5 that in the conventional motor to generate the same output torque. Such a reduced amount of use of costly permanent magnets can contribute to suppression in material cost of the motor.

According to the present embodiment, sufficient output torque can be obtained even when the volume of permanent magnets is small in an application of the motor including a hollow shaft of large diameter, which can consequently yield reductions of material cost and size of the motor. Further, magnetic flux can be controlled in an appropriate manner by means of a function of the multilayer slits provided in the rotor, to thereby obtain superior output characteristics having less torque ripple.

What is claimed is:

1. An electric motor comprising:
a stator which produces a rotating magnetic field by applying a current to a winding;
a rotor formed in a roughly cylindrical shape and rotated in synchronism with the rotating magnetic field, in which a plurality of split magnetic paths separated into strips by a plurality of slits and connecting adjacent magnetic poles are formed to arrange magnetic poles on a circumference of the rotor; and
permanent magnets placed in the slits, wherein
the plurality of slits are composed of a combination of radial slit segments formed in close proximity to a surface of the magnetic poles substantially along a radial direction from a rotor surface toward a center of the rotor, and circumferential slit segments formed in an inner region of the rotor substantially along a circumferential direction or chord direction between adjacent magnetic poles;
the circumferential slit segments are smaller in width than the radial slit segments; and
the permanent magnets are placed only in the circumferential slit segments in such a manner that at least one of the circumferential slit segments includes the permanent magnets at least in areas close to the edges of the circumferential slit segments.

2. An electric motor according to claim 1, wherein the permanent magnets are separately placed, at least in innermost circumferential slit segments, in areas close to the edges of the circumferential slit segments so as to be spaced apart from each other.

3. An electric motor according to claim 1, wherein, in the slits having the permanent magnets, the permanent magnets are placed in the entire interior of each circumferential slit segment.

4. An electric motor according to claim 1, wherein the permanent magnets are placed in all of the slits.

5. An electric motor according to claim 4, wherein each outermost circumferential slit segment includes, in its entire interior, the permanent magnets disposed therein, while the remaining circumferential slit segments include, in areas close to each edge thereof, the permanent magnets disposed separately to be spaced apart from each other.
